(19) United States
(12) Patent Application Publication
(10) Pub. No.: US 2022/0035640 A1
(43) Pub. Date: Feb. 3, 2022

(54) TRAINABLE AGENT FOR TRAVERSING USER INTERFACE

(71) Applicant: ELECTRONIC ARTS INC., Redwood City, CA (US)

(72) Inventors: Bijan Daei, North Vancouver (CA); Paul Robert Ghita, Bucharest (RO); Ivan Doumenc, North Vancouver (CA); Jagtar Gill, Vancouver (CA)

(21) Appl. No.: 16/940,854

(22) Filed: Jul. 28, 2020

(51) Int. Cl. G06F 9/451; A63F 13/46; G06F 11/36; G06N 3/08

(52) U.S. Cl. CPC G06F 9/451; G06N 3/08; G06F 11/3664; A63F 13/46

(57) ABSTRACT

An example method of traversing a user interface of an interactive video game by a trainable agent includes: identifying a current observable state of an interactive video game; computing, by a neural network processing the current observable state, a plurality of user interface actions and their respective action scores; selecting, based on the action scores, a user interface action of the plurality of user interface actions; applying the selected user interface action to the interactive video game; and iteratively repeating the computing, selecting, and submitting operations until a desired target observable state of the interactive video game is reached.

### TECHNICAL FIELD

The present disclosure is generally related to interactive software applications, and is more specifically related to trainable agents for traversing user interfaces of interactive software applications (e.g., interactive video games).

### BACKGROUND

Interactive software applications (such as interactive video games) often have user interfaces spread over multiple screens, which are interconnected in a certain fashion by an internal application logic. Performing a specified task in such an application may require traversing multiple user interface screens in order to arrive at the screen in which the specified task can be performed (e.g., inspecting or setting one or more configuration parameters of the application).

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates a high-level architectural diagram of an example distributed computing system managing and operating trainable agents implemented in accordance with one or more aspects of the present disclosure;

FIG. 2 schematically illustrates an example application user interface which may be traversed by a trainable agent implemented in accordance with aspects of the present disclosure;

FIG. 3 schematically illustrates an example observable state identifier constructed in accordance with aspects of the present disclosure;

FIG. 4 schematically illustrates example observable state transitions, in accordance with aspects of the present disclosure;

FIG. 5 schematically illustrates operation of a trainable agent implemented in accordance with aspects of the present disclosure;

FIG. 6 depicts an example method of traversing a user interface of an interactive application by a trainable agent implemented in accordance with one or more aspects of the present disclosure; and

FIG. 7 schematically illustrates a diagrammatic representation of an example computing device which may implement the systems and methods described herein.

### DETAILED DESCRIPTION

Described herein are methods and systems for implementing trainable agents for traversing user interfaces of interactive software applications. The methods and systems of the present disclosure may be used, for example, for implementing software testing pipelines.

An interactive software application, such as an interactive video game, may implement multiple hierarchical paths for navigating between user interface screens which implement various application use cases and scenarios. For example, a user of an interactive video game may utilize the graphical user interface (GUI) controls (such as, a keyboard, a touchscreen, a pointing device, and/or game controller joysticks and buttons) for logging into the game server via the login screen, selecting game options via the game configuration screen, choosing partners for a multi-party game via the partner selection screen, and then actually playing the game, by issuing GUI control actions in response to audiovisual output rendered via one or more game play screens by the game client device in order to achieve a specified goal. The user action and/or the internal application logic define the next user interface screen to be rendered.

Testing the application may be performed by automated software agents (such as Python scripts or scripts implemented in other scripting language) traversing various user interface paths of the application by issuing GUI control actions in order to perform various application-specific tasks. Development and maintenance of scripts implementing such agents require a considerable amount of programming resources, and thus can be expensive and error-prone. Furthermore, one or more scripts need to be developed and/or modified for testing each newly released software build, and thus the software release becomes delayed by at least the duration of the script development effort.

The systems and methods of the present disclosure alleviate this and other deficiencies of various manual or semi-automated scripting techniques by implementing trainable agents for traversing user interfaces of interactive software applications. Such agents usually cannot observe the internal application state, while only observing the user interface screens rendered by the application. A trainable agent implemented in accordance with aspects of the present disclosure may automatically discover multiple paths traversing the user interface and may further automatically adapt itself to changes in the previously discovered paths, and thus allows dramatically decreasing the amount of human effort involved in developing and maintaining software testing pipelines.

In some implementations, a trainable agent may be implemented by a neural network. “Neural network” herein shall refer to a computational model, which may be implemented by software, hardware, or combination thereof. A neural network includes multiple inter-connected nodes called “artificial neurons,” which loosely simulate the neurons of a living brain. An artificial neuron processes a signal received from another artificial neuron and transmit the transformed signal to other artificial neurons. The output of each artificial neuron may be represented by a function of a linear combination of its inputs. Edge weights, which increase or attenuate the signals being transmitted through respective edges connecting the neurons, as well as other network parameters, may be determined at the network training stage, as described in more detail herein below.

A trainable agent implemented in accordance with aspects of the present disclosure receives a numeric vector identifying the observable state (e.g., the screen identifier, the menu identifier, the selected menu item identifier, or their various combinations) and produces a set of possible user interface actions and their respective scores, such that a score associated with a particular user interface action indicates the likelihood of that user interface action triggering a observable state transition that belongs to the shortest path from the current observable state to the desired observable state (i.e., the user interface action associated with the maximum score is the most likely action to activate the shortest path to the desired observable state). The neural network may be trained by a reinforcement learning procedure, as described in more detail herein below.

As noted herein above, the trainable agents implemented in accordance with aspects of the present disclosure may be utilized for software testing (including, e.g. functional testing, load testing, etc.). In an illustrative example, functional testing of an application may involve employing multiple trainable agents to achieve various target observable states and logging the application errors that may be triggered by the user interface actions that are applied to the application by the trainable agents. In an illustrative example, load testing of an application may involve employing multiple trainable agents to achieve various target observable states, while monitoring the usage level of various computing resources (e.g., processor, memory, network bandwidth, etc.) by one or more servers running the application. Furthermore, various other use cases employing trainable agents for traversing user interfaces of interactive software applications fall within the scope of the present disclosure.

Various aspects of the methods and systems for implementing trainable agents for traversing user interfaces of interactive software applications s are described herein by way of examples, rather than by way of limitation. The methods described herein may be implemented by hardware (e.g., general purpose and/or specialized processing devices, and/or other devices and associated circuitry), software (e.g., instructions executable by a processing device), or a combination thereof.

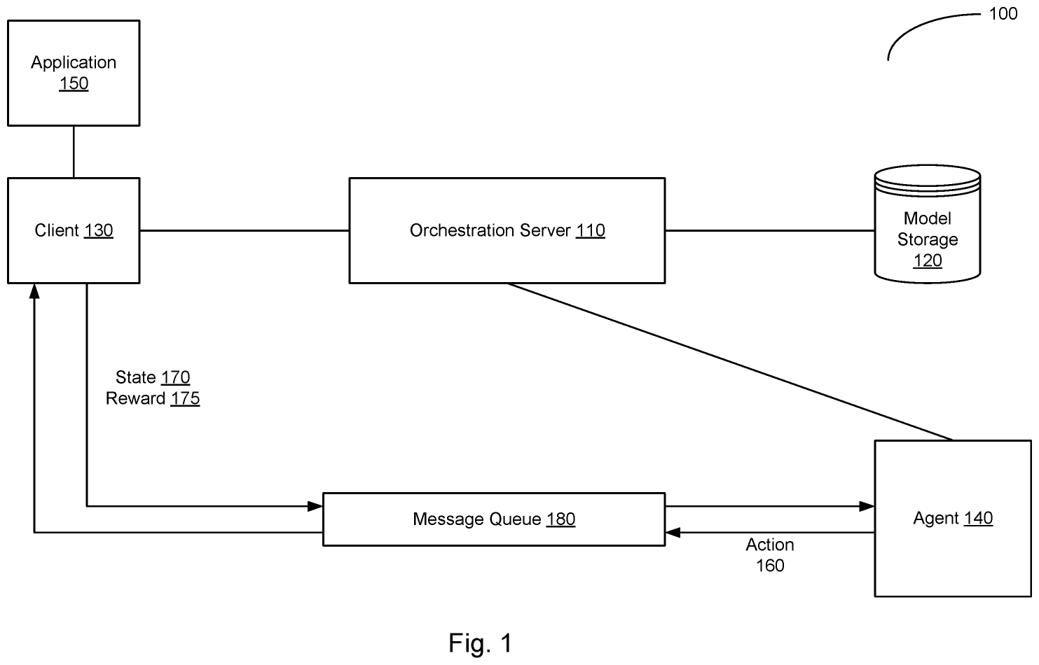

FIG. 1 schematically illustrates a high-level architectural diagram of an example distributed computing system managing and operating trainable agents implemented in accordance with one or more aspects of the present disclosure. The example distributed computing system 100 is managed by the orchestration server 110 which controls the model storage 120, one or more application clients 130 and one or more trainable agents 140.

Computing devices, appliances, and network segments are shown in FIG. 1 for illustrative purposes only and do not in any way limit the scope of the present disclosure. Various other computing devices, components, and appliances not shown in FIG. 1, and/or methods of their interconnection may be compatible with the methods and systems described herein. Various functional or auxiliary network components (e.g., firewalls, load balancers, network switches, user directories, content repositories, etc.) may be omitted from FIG. 1 for clarity.

An agent 140 may utilize one or more models (i.e., executable modules implementing neural networks and parameters of the neural networks) that may be retrieved from the model storage 120. The agent 140 traverses various user interface paths by issuing GUI control actions to the application client 130 in order to perform various application-specific tasks (e.g., assigning certain values to one or more application parameters or performing another application-specific interaction, such as achieving a certain observable state of an interactive video game). In some implementations, communications between the client 130 and the agent 140 are facilitated by the message queue 180, which may be implemented, e.g., by a duplex message queue.

The application client 130 acts as an interface between the agent 140 and the application being tested 150. The application client 130 executes the user interface actions 160 received from the agent 140 and returns the observable state 170 and an optional reward 175 to the agent 140.

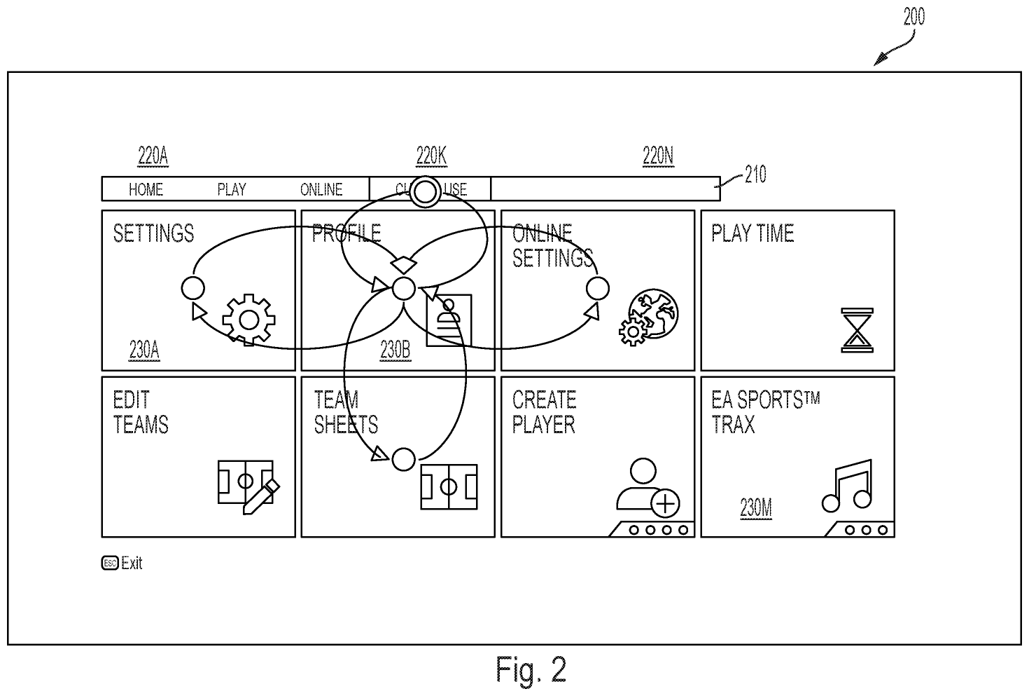

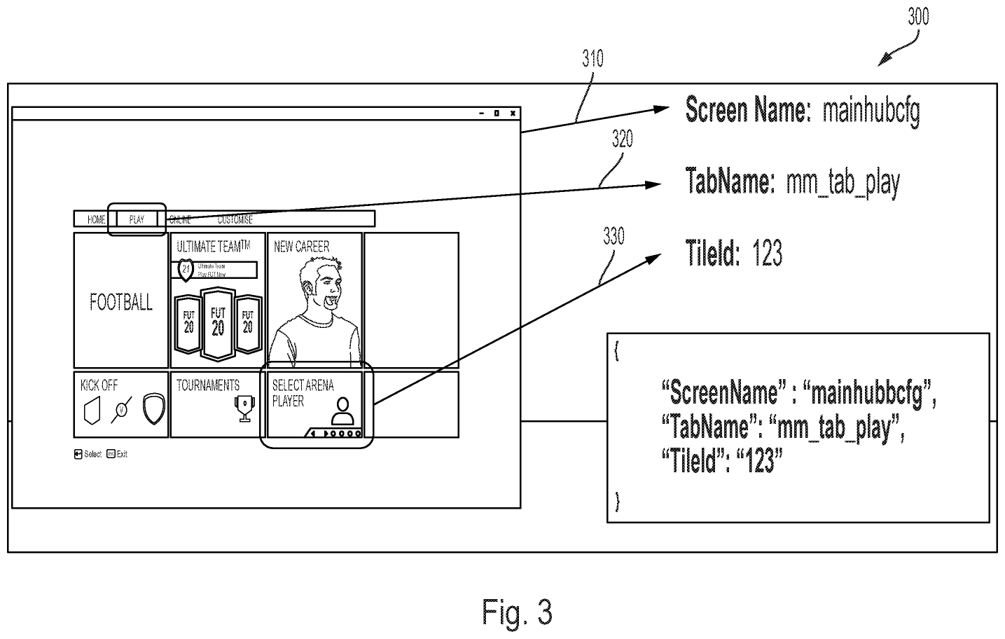

FIG. 2 schematically illustrates an example application user interface which may be traversed by a trainable agent implemented in accordance with aspects of the present disclosure. As shown in FIG. 2, the example user interface includes the main menu 210, which in turn includes several tabs 220A-220N. Selecting a tab 220K would activate multiple buttons 230A-230M, each of which would in turn activate a game parameter configuration screen identified by the tab legend. Accordingly, as schematically illustrated by FIG. 3, which schematically illustrates an example observable state identifier constructed in accordance with aspects of the present disclosure, a observable state may be identified by the screen identifier 310, the menu identifier 320, the selected menu tab identifier 330, and/or their various combinations.

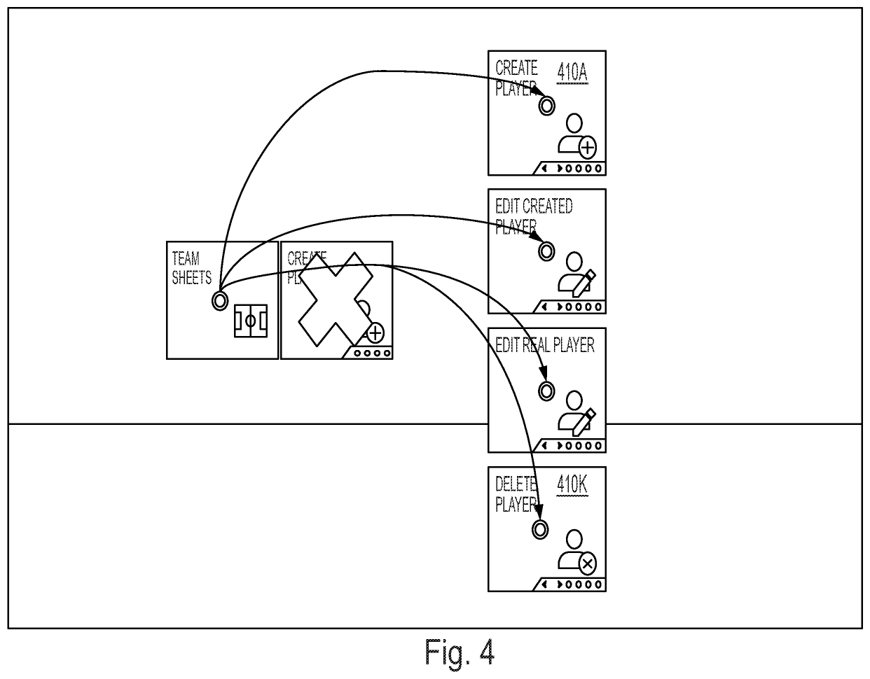

Referring again to FIG. 1, the application client 130 executes the user interface actions 160 received from the agent 140 and returns the observable state 170 and an optional reward 175 to the agent 140. A user interface action may be by represented by depressing or releasing a certain game controller button, depressing and releasing a certain key on the keyboard, performing a certain pointing device action, and/or a combination of these actions. As schematically illustrated by FIG. 4, which schematically illustrates example observable state transitions, each of the tiles 410A-410K of the example user interface screen 400 may be selected by a corresponding sequence of user interface actions, thus activating a corresponding configuration screen identified by the tab legend.

Referring again to FIG. 1, the optional reward returned by the application client 130 to the agent 140 along with the new observable state may be represented by a numeric value that reflects the likelihood of the new observable state belonging to the shortest path from the current observable state to the desired observable state. Therefore, the agent's goal may be formulated as selecting a sequence of user interface actions that would maximize the total reward. Not every observable state transition may yield a reward. In some implementations, only terminal observable states are associated with rewards. The rewards associated with observable states are specified by the script implementing the agent 140, as described in more detail herein below.

The orchestration server 100 implements version control of the models and coordinates training and production sessions by agents using the models that are stored in the model storage 120. In some implementations, each application build of the application 150 has a corresponding set of models stored in the model storage 120, such that each model implements an agent for achieving a certain target observable state of the application user interface (e.g., assigning certain values to one or more application parameters or performing another application-specific interaction, such as achieving a certain observable state of an interactive video game). The version control may be implemented by associating, for each application build, the application build version number with the corresponding version number identifying one or more agents that have been trained on that particular application build.

Accordingly, when a new application build of the application 150 is released, the orchestration server 100 may initiate one or more training sessions for each model of the set of models associated with the application 150. Initiating a training session involves spawning a certain number of agents 140 using the models retrieved from the model storage 120. In an illustrative example, the set of models corresponding to the previous application build can be re-trained for the newly released application build. Alternatively, should the re-training attempt fail, a new set of models can be built (e.g., by resetting all neural network parameters to their default values) and trained for the newly released application build.

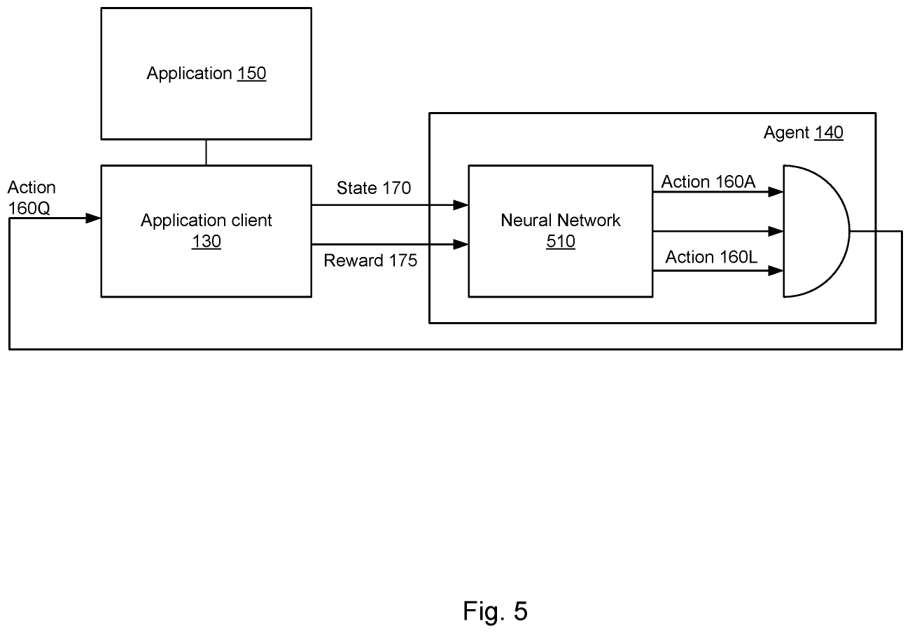

In some implementations, the agent 140 may be trained by a reinforcement learning method, which causes the agent to select user interface actions in order to maximize the cumulative reward over the user interface path from the current observable state to the target observable state. Accordingly, a training session may involve running one or more trained agents 140, such that each agent 140 is assigned a certain goal (e.g., assigning certain values to one or more application parameters or performing another application-specific interaction, such as achieving a certain observable state of an interactive video game). As shown in FIG. 5, which schematically illustrates operation of a trainable agent implemented in accordance with aspects of the present disclosure, the agent 140 may iteratively navigate the user interface screens of the application 510 to be tested. At every iteration, the agent 140 may feed, to the neural network 510, a vector of numeric values identifying the observable state 170. The observable state 170 be represented, e.g., by the screen identifier, the menu identifier, the selected menu item identifier, or their various combinations. The vector of numeric values representing the observable state may be a one-hot encoding of the observable state. In an illustrative example, the highest possible number of variations of each feature is assumed (e.g., the highest possible number of screens, the highest possible number of menus, the highest possible number of menu items, etc.), and a dictionary is built for each feature, such that a dictionary entry associates a symbolic feature value (e.g., a symbolic screen name, a symbolic menu name, or a symbolic menu item name) with its numeric representation. A concatenation of these numeric representations would thus become a numeric representation of the observable state 170.

Upon receiving the numeric representation of the observable state 170, the neural network 510 would process produce a set of possible user interface actions 160A-160L and their respective scores, such that a score associated with a particular user interface action 160 indicates the likelihood of that user interface action triggering a observable state transition that belongs to the shortest path from the current observable state to the desired observable state (i.e., the user interface action associated with the maximum score is the most likely action to activate the shortest path to the desired observable state).

The agent 140 selects, with a known probability £, either a random user interface action or the user interface action 160 associated with the highest score among the candidate user interface actions produced by the neural network. The probability c may be chosen as a monotonically-decreasing function of the number of training iteration, such that the probability would be close to one at the initial iterations (thus forcing to agent to prefer random user interface actions over the actions produced by the untrained agent) and then would decrease with iterations to asymptotically approach a predetermined low value, thus giving more preference to the neural network output as the training progresses.

The agent 140 communicates the selected user interface action 160Q to the application client 130. The application client 130 applies, to the application 150, the user interface action 160Q received from the agent 140 and returns the new observable state 170 and an optional reward 175 to the agent 140.

The iterations may continue until the target observable state is reached or until an error condition is detected (e.g., a predetermined threshold number of iterations through user interface screens is exceeded or the neural network returning no valid user interface actions for the current observable state).

Referring again to FIG. 1, upon completing the training session, the orchestration server 110 may validate the trained model by running it multiple times with added noise forcing the agent 140 to select, with a known small probability y, either a random user interface action or the user interface action associated with the highest score among the candidate user interface actions produced by the neural network. The orchestration server 110 may store the validated models in the model storage 120 in association with the application build that was utilized for model training.

The orchestration server 110 further manages production environments created in the distributed computing system 100. A production environment can be created e.g., for testing a new application build and/or for performing other application-specific tasks. A production environment includes multiple trainable agents 140 in communication with respective application clients 130. The orchestration server 110 may start a production session, e.g., for testing the newly released application build, by spawning a certain number of agents 140 using a set of pre-trained models corresponding to the application build. As noted herein above, the pre-trained models may be stored in the model storage 120 and may be retrieved by the orchestration server for initiating the production session.

A production session may involve running one or more trained agents 140, such that each agent 140 is assigned a certain goal (e.g., assigning certain values to one or more application parameters or performing another application-specific interaction, such as achieving a certain observable state of an interactive video game). The agent 140 may iteratively navigate the user interface screens of the application being tested. As schematically illustrated by FIG. 5, at every iteration, the agent 140 may feed, to the trained neural network 510, a numeric vector identifying the observable state (e.g., the screen identifier, the menu identifier, the selected menu item identifier, or their various combinations). The neural network 510 produces a set of possible user interface actions and their respective scores, such that a score associated with a particular user interface action indicates the likelihood of that user interface action triggering a observable state transition that belongs to the shortest path from the current observable state to the desired observable state (i.e., the user interface action associated with the maximum score is the most likely action to activate the shortest path to the desired observable state).

In some implementations, the agent 140 selects, among the candidate user interface actions produced by the neural network 510, the user interface action associated with the highest score. Alternatively, stochastic noise may be introduced, which would force the agent 140 to select, with a known small probability y, either a random user interface action or the user interface action associated with the highest score among the candidate user interface actions produced by the neural network. The agent 140 and communicates the selected user interface action 160 to the application client 130. The application client 130 executes the user interface actions 160 received from the agent 140 and returns the new observable state 170 and an optional reward 175 to the agent 140.

The iterations may continue until the target observable state is reached or until an error condition is detected (e.g., a predetermined threshold number of iterations through user interface screens is exceeded or the neural network returning no valid user interface actions for the current observable state).

Referring again to FIG. 1, upon completing the production session, the orchestration server 110 may generate a session report, which may indicate, for each model, the number of successful and unsuccessful runs of each model of the set of pre-trained models associated with the application 150, the aggregate running times (e.g., the minimum, the average, and/or the maximum time), the number of errors of each type, identifiers of the observable states associated with each error type, etc.

As noted herein above, trainable agents implemented in accordance with aspects of the present disclosure may be employed for implementing software testing pipelines. A trainable agent is an executable software module, which may be implemented by a Python script or using any other scripting language and/or one or more high level programming language. The script is programmed for traversing various user interface paths of the application by issuing GUI control actions in order to perform various application-specific tasks. The script specifies the target observable state, one or more optional intermediate observable states, and the reward values associated with the target observable state and the intermediate observable states. In an illustrative example, the reward values may be positive integer or real values, such that the maximum reward value is associated with the target observable state of the application.

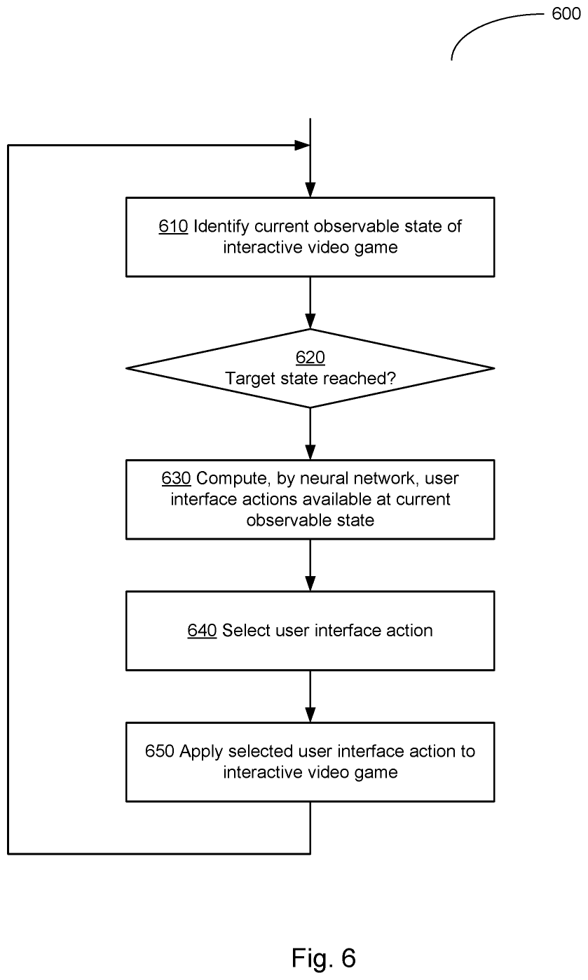

FIG. 6 depicts an example method of traversing a user interface of an interactive application by a trainable agent implemented in accordance with one or more aspects of the present disclosure. As noted herein above, the trainable agents may be employed for performing application testing (including, e.g. functional testing, load testing, etc.) and/or various other application-specific tasks. In an illustrative example, functional testing of an application may involve employing multiple trainable agents to achieve various target observable states and logging the application errors that may be triggered by the user interface actions that are applied to the application by the trainable agents. In an illustrative example, load testing of an application may involve employing multiple trainable agents to achieve various target observable states, while monitoring the usage level of various computing resources (e.g., processor, memory, network bandwidth, etc.) by one or more servers running the application.

Accordingly, method 600 may be implemented by the agent 140 of FIG. 1. As noted herein above, the script implementing the agent 140 may specify the target observable state of the application, one or more optional intermediate observable states of the application, and the reward values associated with the target observable state and the intermediate observable states

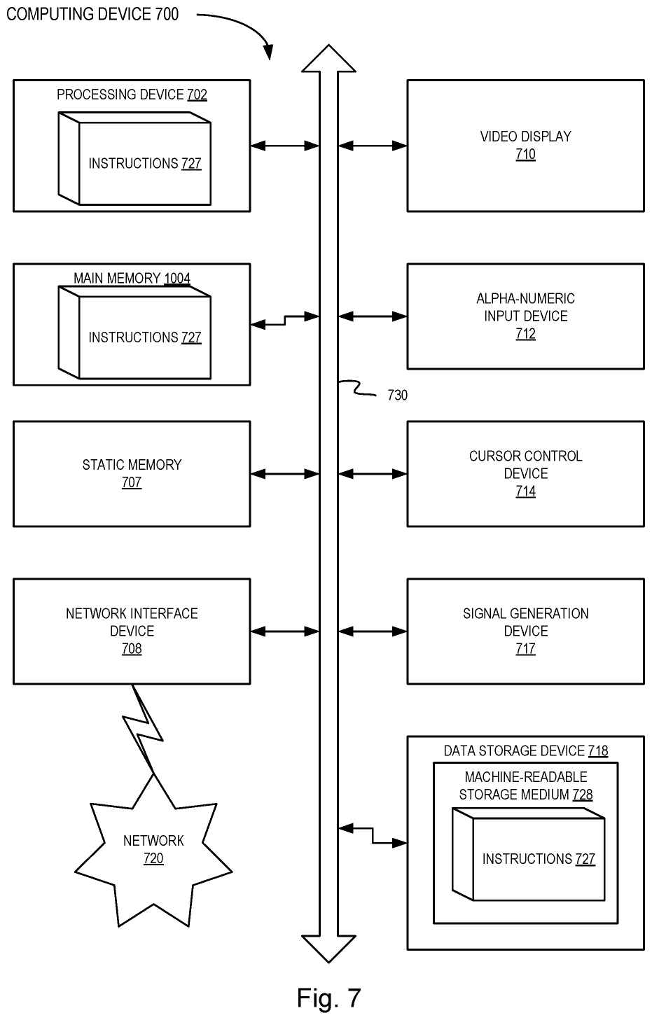

Method 600 and/or each of its individual functions, routines, subroutines, or operations may be performed by one or more processors of a computing device (e.g., computing device 700 of FIG. 7). In certain implementations, method 600 may be performed by a single processing thread. Alternatively, method 600 may be performed by two or more processing threads, each thread executing one or more individual functions, routines, subroutines, or operations of the method. In an illustrative example, the processing threads implementing method 600 may be synchronized (e.g., using semaphores, critical sections, and/or other thread synchronization mechanisms). Alternatively, the processing threads implementing method 600 may be executed asynchronously with respect to each other. Therefore, while FIG. 6 and the associated description lists the operations of method 600 in certain order, various implementations of the method may perform at least some of the described operations in parallel and/or in arbitrary selected orders.

As schematically illustrated by FIG. 6, at block 610, the computing device implementing the method identifies a current observable state of an interactive application. In an illustrative example, the interactive application may be an interactive video game. In some implementations, the current observable state of the interactive application may be represented by a vector of numeric values characterizing one or more parameters of the current GUI screen, as described in more detail herein above.

Responsive to determining, at block 620, that the current observable state matches the target observable state, the method terminates; otherwise, the processing continues at block 630.

At block 630, the computing device feeds the vector of numeric values representing the current observable state to a neural network, which generates a plurality of user interface actions available at the current observable state and their respective action scores. The action scores may be represented by positive integer or real values. In an illustrative example, the neural network may be retrieved from the model storage 120 by the orchestration server 110 of FIG. 1. The version of the neural network may match the version of the interactive application that is being observed by the computing device implementing the method, as described in more detail herein above.

At block 640, the computing device selects, based on the action scores, a user interface action of the plurality of UI actions. In an illustrative example, the computing device selects the user interface action associated with the optimal (e.g., maximal or minimal) score among the scores associated with the user interface actions produced by the neural network. In another illustrative example, e.g., for training the neural network, the computing device selects, with a known probability ε, either a random user interface action or the user interface action associated with the highest score among the user interface actions produced by the neural network, as described in more detail herein above.

At block 650, the computing device applies the selected action to the interactive application, as described in more detail herein above. In an illustrative example, responsive to detecting an error in the interactive application (e.g., caused by the agent performing a certain user interface action or a sequence of user interface actions), the computing device may log the error in association with the observable state and the user interface actions applied. In an illustrative example, responsive to detecting an error in the interactive application, the computing device may initiate re-training of the neural network in order to modify one or more parameters of the neural network, as described in more detail herein above.

The operations of block 610-650 are repeated iteratively until the target observable state of the interactive application is reached. Accordingly, responsive to completing operations of block 650, the method loops back to block 610. In some implementations, responsive to failing to achieve the desired observable state of the interactive application within a predefined number of iterations, the computing device may initiate re-training of the neural network in order to modify one or more parameters of the neural network, as described in more detail herein above.

FIG. 7 schematically illustrates a diagrammatic representation of a computing device 700 which may implement the systems and methods described herein. Computing device 700 may be connected to other computing devices in a LAN, an intranet, an extranet, and/or the Internet. The computing device may operate in the capacity of a server machine in client-server network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device (e.g., a general purpose processor) 702, a main memory 704 (e.g., synchronous dynamic random access memory (DRAM), read-only memory (ROM)), a static memory 707 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also comprise one or more special-purpose processing devices such as an application specific integrated circuit (ASIC), a field programmable gate array (FPGA), a digital signal processor (DSP), network processor, or the like. The processing device 702 may be configured to execute module 727 implementing method 600 of traversing a user interface of an interactive application by a trainable agent implemented in accordance with one or more aspects of the present disclosure.

Computing device 700 may further include a network interface device 707 which may communicate with a network 720. The computing device 700 also may include a video display unit 77 (e.g., a liquid crystal display (LCD) or a cathode ray tube (CRT)), an alphanumeric input device 712 (e.g., a keyboard), a cursor control device 714 (e.g., a mouse) and an acoustic signal generation device 717 (e.g., a speaker). In one embodiment, video display unit 77, alphanumeric input device 712, and cursor control device 714 may be combined into a single component or device (e.g., an LCD touch screen).

Data storage device 718 may include a computer-readable storage medium 728 on which may be stored one or more sets of instructions, e.g., instructions of module 727 implementing method 600 of traversing a user interface of an interactive application by a trainable agent implemented in accordance with one or more aspects of the present disclosure. Instructions implementing module 727 may also reside, completely or at least partially, within main memory 704 and/or within processing device 702 during execution thereof by computing device 700, main memory 704 and processing device 702 also constituting computer-readable media. The instructions may further be transmitted or received over a network 720 via network interface device 707.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “updating”, “identifying”, “determining”, “sending”, “assigning”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

What is claimed is:

1. A method, comprising:
identifying a current observable state of an interactive video game;
computing, by a neural network processing the current observable state, a plurality of user interface actions and their respective action scores;
selecting, based on the action scores, a user interface action of the plurality of user interface actions;
applying the selected user interface action to the interactive video game; and
iteratively repeating the computing, selecting, and applying operations until a desired target observable state of the interactive video game is reached.

2. The method of claim 1, wherein selecting the user interface action further comprises:
selecting a user interface action that is associated with an optimal action score among the action scores.

3. The method of claim 1, wherein the current observable state of the interactive video game is represented by a numeric vector characterizing one or more parameters of a current graphical user interface (GUI) screen.

4. The method of claim 1, wherein the current observable state of the interactive video game is associated with a reward value, and wherein the neural network is trained to maximize overall reward accumulated by traversing a user interface path to the desired target observable state of the interactive video game.

5. The method of claim 1, further comprising:
identifying the neural network among a plurality of neural networks associated with the interactive video game, by matching a version identifier of the neural network to a version identifier of the interactive video game.

6. The method of claim 1, further comprising:
responsive to detecting an error in the interactive video game, modifying one or more parameters of the neural network.

7. The method of claim 1, further comprising:
responsive to failing to achieve the desired observable state of the interactive video game within a predefined number of iterations, modifying one or more parameters of the neural network.

8. The method of claim 1, further comprising:
training the neural network by a reinforcement learning process.

9. A system, comprising:
a memory; and
a processor, communicatively coupled to the memory, the processor configured to:
identify a current observable state of an interactive video game;
compute, by a neural network processing the current observable state, a plurality of user interface actions and their respective action scores;
select, based on the action scores, a user interface action of the plurality of user interface actions;
apply the selected user interface action to the interactive video game; and
iteratively repeat the computing, selecting, and applying operations until a desired target observable state of the interactive video game is reached.

10. The system of claim 9, wherein the interactive video game is an interactive video game.

11. The system of claim 9, wherein selecting the user interface action further comprises:
selecting a user interface action that is associated with an optimal action score among the action scores.

12. The system of claim 9, wherein the current observable state of the interactive video game is represented by a numeric vector characterizing one or more parameters of a current graphical user interface (GUI) screen.

13. The system of claim 9, wherein the processor is further configured to:
identify the neural network among a plurality of neural networks associated with the interactive video game, by matching a version identifier of the neural network to a version identifier of the interactive video game.

14. The system of claim 9, wherein the processor is further configured to:
responsive to detecting an error in the interactive video game, modify one or more parameters of the neural network.

15. The system of claim 9, wherein the processor is further configured to:
responsive to failing to achieve the desired observable state of the interactive video game within a predefined number of iterations, modify one or more parameters of the neural network.

16. A computer-readable non-transitory storage medium comprising executable instructions that, when executed by a computing device, cause the computing device to:
identify a current observable state of an interactive video game;
compute, by a neural network processing the current observable state, a plurality of user interface actions and their respective action scores;
select, based on the action scores, a user interface action of the plurality of user interface actions;
apply the selected user interface action to the interactive video game; and
iteratively repeat the computing, selecting, and applying operations until a desired target observable state of the interactive video game is reached.

17. The computer-readable non-transitory storage medium of claim 16, wherein selecting the user interface action further comprises:
selecting a user interface action that is associated with an optimal action score among the action scores.

18. The computer-readable non-transitory storage medium of claim 16, wherein the current observable state of the interactive video game is represented by a numeric vector characterizing one or more parameters of a current graphical user interface (GUI) screen.

19. The computer-readable non-transitory storage medium of claim 16, wherein the current observable state of the interactive video game is associated with a reward value, and wherein the neural network is trained to maximize overall reward accumulated by traversing a user interface path to the desired target observable state of the interactive video game.

20. The computer-readable non-transitory storage medium of claim 16, further comprising executable instructions that, when executed by the computing device, cause the computing device to:
identify the neural network among a plurality of neural networks associated with the interactive video game, by matching a version identifier of the neural network to a version identifier of the interactive video game.
